(19) United States
(12) Patent Application Publication
(10) Pub. No.: US 2014/0182435 A1
(43) Pub. Date: Jul. 3, 2014

(54) NANOTUBE SLICER

(71) Applicant: ELWHA LLC, Bellevue, WA (US)

(72) Inventors: Michael H. Baym, Cambridge, MA (US); W. Daniel Hillis, Encino, CA (US); Roderick A. Hyde, Redmond, WA (US); Muriel Y. Ishikawa, Livermore, CA (US); Jordin T. Kare, Seattle, WA (US); Conor L. Myhrvold, Medina, WA (US); Nathan P. Myhrvold, Medina, WA (US); Tony S. Pan, Cambridge, MA (US); Clarence T. Tegreene, Mercer Island, WA (US); Charles Whitmer, North Bend, WA (US); Lowell L. Wood, JR., Bellevue, WA (US); Victoria Y.H Wood, Livermore, CA (US)

(73) Assignee: Elwha LLC, Bellevue, WA (US)

(21) Appl. No.: 13/729,098

(22) Filed: Dec. 28, 2012

(51) Int. Cl. B26D 1/547; B26D 7/10; B26D 3/00

(52) U.S. Cl. CPC B26D 1/547; B26D 3/00; B26D 7/10
USPC 83/171; 83/651.1; 83/401

(57) ABSTRACT

A device for slicing material includes a structural support and a nanotube blade. The nanotube blade includes a nanotube filament having atoms arranged in a lattice structure and has a first end and a second end. Both the first end and the second end are coupled to the structural support and separated by a length of the nanotube blade.

### CROSS REFERENCE TO RELATED APPLICATIONS

This application is related to U.S. application Ser. No. ______ (Attorney Docket No. 103315-0159), titled “Nanotube Slicer,” filed Dec. 28, 2012 which is incorporated herein by reference in its entirety.

### BACKGROUND

The manufacturing industry presently uses a variety of machines to reduce the size of relatively small material particles, remove material from and an above- or below-ground mine, cut the removed material into smaller sections, or perform other cutting or slicing operations. Reducing the size of a material (e.g., a mineral, ore, paint, cement, etc.) from an initial size of less than one centimeter typically involves milling. Such milling operations may include ball, semi-autogenous grinding, or still other types of milling. Ball mills reduce the size of a material by crushing the particles with grinding balls. Semi-autogenous mills operate similar to ball mills, but use the material particles and a smaller number of grinding balls to crush the material.

Both ball mills and semi-autogenous mills reduce the size of material from an initial size of less than one centimeter. Many moving parts necessitate sophisticated maintenance schedules on these machines. These mills require a substantial amount of energy to operate and possess mechanical and electrical efficiencies as low as two percent. Further, mills produce material particles that often vary widely in size. Variation in particle size of the processed material complicates the design of other processing machinery and may lead to over or under processing the material.

Other machines or processing methods are utilized to remove material from an above- or below-ground mine. By way of example, a mining operation may utilize a blasting method to break free large amounts of material from the surrounding ground volume. However, blasting techniques may involve safety risks and may produce non-uniform samples of material. Other mining operations utilize a rope saw to extract blocks of material from an above or below-ground mine. Such a rope saw may include a plurality of sections having an embedded abrasive (e.g., diamond, etc.) that each remove a small amount of material as it passes over the material. Operators may cycle the saw within pre-drilled holes cut into the material and maintain tension on the rope saw to cut the material into blocks.

Still other machines are utilized to section large samples of material. A large sample of material, such as those removed from the mine using a rope saw, may be reduced into smaller sections using a saw having a circular blade. By way of example, the circular blade may include teeth that each remove material until the block of material is separated. While sawing, particularly rope sawing, may produce uniform samples of material, saws require numerous moving parts, require large amounts of energy to operate, may produce slurries as a result of lubricating fluid, and may waste material removed by the saw blade. However, these processes for cutting material are not inherently energy intensive given the relatively brittle nature of material.

Traditional methods for removing and processing material are energy inefficient. Traditional methods for removing and processing material include blasting and sawing. Lack of uniformity in the particle size of processed material complicates the design of other processing machinery and may lead to over or under processing the material. Despite these deficiencies, milling, blasting, and sawing remain the primary methods used for extracting, reducing, and further sectioning material.

### SUMMARY

One exemplary embodiment relates to a device for slicing material including a structural support and a nanotube blade. The nanotube blade includes a nanotube filament having atoms arranged in a lattice structure and has a first end and a second end. Both the first end and the second end are coupled to the structural support and separated by a length of the nanotube blade.

Another exemplary embodiment relates to a device for reducing the size of a material particle including a slicer and a driver. The slicer includes a structural support and a nanotube blade that includes a nanotube filament having atoms arranged in a lattice structure and having a first end and a second end. Both the first end and the second end are coupled to the structural support and separated by a length of the nanotube blade. The driver is configured to move the material particle into cutting engagement with the slicer.

Still another exemplary embodiment relates to a device for reducing the size of a material particle including a slicer and a channel. The slicer includes a structural support and a nanotube blade that includes a nanotube filament having atoms arranged in a lattice structure and having a first end and a second end. Both the first end and the second end are coupled to the structural support and separated by a length of the nanotube blade. The channel is configured to receive a fluid flow.

Still another exemplary embodiment relates to a method for slicing material that includes providing a structural support, providing a nanotube blade including a nanotube filament having a first end and a second end, and attaching the first end and the second end to the structural support. The first end and the second end are separated by a length of the nanotube blade.

Yet another exemplary embodiment relates to a method for reducing the size of a material particle that includes providing a slicer and providing a driver configured to move the material particle into cutting engagement with the slicer. The slicer includes a structural support and a nanotube blade that includes a nanotube filament having atoms arranged in a lattice structure and has a first end and a second end. The first end and the second end are coupled to the structural support and separated by a length of the nanotube blade.

Yet another exemplary embodiment relates to a method for reducing the size of a material particle including providing a channel and providing a slicer. The slicer includes a structural support and a nanotube blade that includes a nanotube filament having atoms arranged in a lattice structure and having a first end and a second end. The first end and the second end are coupled to the structural support and separated by a length of the nanotube blade. The channel is configured to receive a fluid flow.

The invention is capable of other embodiments and of being carried out in various ways. Alternative exemplary embodiments relate to other features and combinations of features as may be generally recited in the claims.

### BRIEF DESCRIPTION OF THE FIGURES

The invention will become more fully understood from the following detailed description taken in conjunction with the accompanying drawings wherein like reference numerals refer to like elements, in which:

FIG. 1 is an elevation view of a nanotube slicer blade, according to an exemplary embodiment.

FIG. 2 is an elevation view of a nanotube slicer blade, according to an alternative embodiment.

FIG. 3 is an elevation view of nanotube blades arranged parallel to one another in a structural support, according to an exemplary embodiment.

FIG. 4 is an elevation view of nanotube blades arranged in a rectangular array in a structural support, according to an alternative embodiment.

FIG. 5 is an elevation view of nanotube blades arranged in a triangular array in a structural support, according to an alternative embodiment.

FIG. 6 is an elevation view of a nanotube blade coupled with a structural support using a mounting hole, according to an exemplary embodiment.

FIG. 7 is an elevation view of a nanotube blade wrapped around a portion of a structural support, according to an alternative embodiment.

FIG. 8 is an elevation view of a nanotube blade coupled to a support with an end assembly, according to an exemplary embodiment.

FIG. 9 is a sectional view of nanotube filaments arranged in a bundle, according to an exemplary embodiment.

FIG. 10 is an elevation view of nanotube filaments arranged in a braid, according to an alternative embodiment.

FIG. 11 is an elevation view of nanotube filaments arranged in a yarn, according to an alternative embodiment.

FIG. 12 is a section view of a nanotube blade surrounded by a coating, according to an exemplary embodiment.

FIG. 13 is an elevation view of a nanotube filament surrounded by a coating, according to an exemplary embodiment.

FIG. 14 is an elevation view of the microstructure of a nanotube filament, according to an exemplary embodiment.

FIG. 15 is an elevation view of a slicing element disposed along a channel and configured to reduce the size of a material, according to an exemplary embodiment.

FIG. 16 is an elevation view of a driven system for reducing the size of a material, according to an exemplary embodiment.

FIG. 17 is an elevation view of a heated system for reducing the size of a material, according to an exemplary embodiment.

FIG. 18 is a schematic view of a material deposit located at a material processing facility.

FIG. 19 is a schematic view of a material deposit and a material sample at a material processing facility.

FIG. 20 is an elevation view of a nanotube slicer configured to remove material from a ground deposit, according to an exemplary embodiment.

FIG. 21 is an elevation view of a nanotube slicer configured to section a material sample into several pieces, according to an exemplary embodiment.

FIG. 22 is an elevation view of an actuated nanotube slicer configured to section a material sample into several pieces, according to an exemplary embodiment.

FIG. 23 is an elevation view of a driven rope slicer for removing or processing material according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Nanotube slicing equipment is intended to provide an energy efficient alternative to traditional crushing and grinding equipment that reduces the size of material initially measuring less than approximately one centimeter. Nanotube slicing equipment also provides an energy efficient alternative to the traditional sawing equipment that removes material from an above- or below-ground mine and divides the material into smaller sections. Such nanotube slicing equipment utilizes the inherent tensile strength of nanotubes in order to facilitate a slicing operation.

Nanotubes may be added to other materials to form composite materials with improved strength, fracture toughness, wear properties, or other properties, as described in, for example, United States Patent Publication No. 2008/0210473 titled “Hybrid Carbon Nanotube Reinforced Composite Bodies.” Such composite materials may be used in components of cutting or grinding machines, mills, or other machinery, including in cutting bits or blades. However, in such known uses, the nanotubes are employed as a bulk additive and do not qualitatively change the nature of the rock processing.

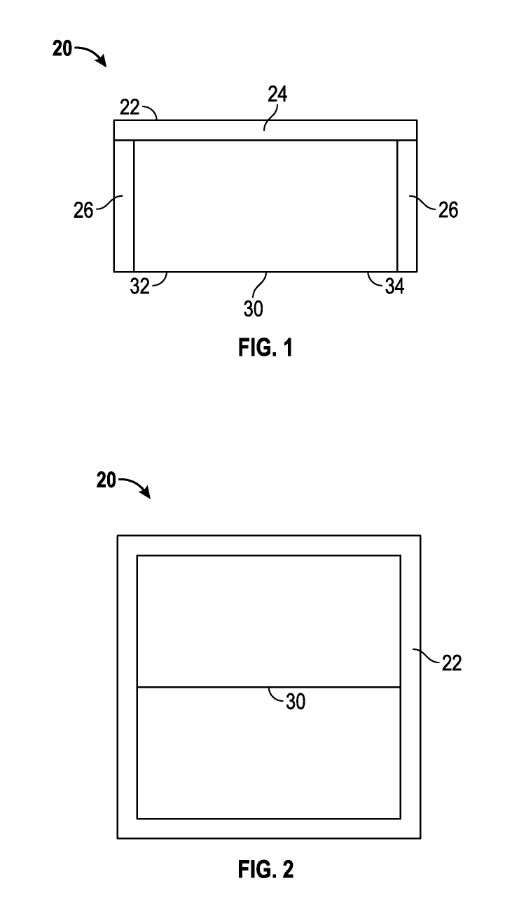

Referring to the exemplary embodiment shown in FIGS. 1-2, a slicing device, shown as nanotube slicer 20 includes a nanotube blade, shown as nanotube blade 30. According to an exemplary embodiment, nanotube blade 30 is an element that slices into or through a volume of material (e.g., a mineral, ore, paint, cement, etc.). As shown in FIG. 1, nanotube blade 30 includes a first end 32 and a second end 34 separated by a length (e.g., the entire length, a portion of the entire length, etc.) of nanotube blade 30. According to an exemplary embodiment, nanotube blade 30 is configured within nanotube slicer 20 under a preload tension. According to an alternative embodiment, nanotube blade 30 is not under a preload tension (i.e. first end 32 may be spaced a distance from second end 34 that is less than a length of nanotube blade 30).

Referring still to the exemplary embodiment shown in FIGS. 1-2, nanotube slicer 20 includes a structural support, shown as structural support 22. As shown in FIGS. 1-2, structural support 22 partially surrounds nanotube blade 30. According to an exemplary embodiment, structural support 22 includes a first support member, shown as top support 24, and two arms, shown as support arms 26. As shown in FIG. 1, support arms 26 are elongated members each having an end that is coupled to top support 24. According to an exemplary embodiment, support arms 26 extend downward and away from top support 22. Such support arms 26 may also each include an end coupled to one of first end 32 and second end 34 of nanotube blade 30. The nanotube slicer 20 having a structural support 22 and arms 26 arranged as shown in FIG. 1 may provide various advantages (e.g., providing access or clearance below nanotube blade 30, etc.).

According to the alternative embodiment shown in FIG. 2, structural support 22 is ring-shaped and partially surrounds both the top and bottom of nanotube blade 30. As shown in FIG. 2, first end 32 and second end 34 of nanotube blade 30 are coupled to structural support 22. A ring-shaped structural support 22 provides at least the benefit that structural support 22 may be coupled with surrounding equipment at least one of above, below, and to the sides of nanotube blade 30. While the embodiments shown in FIGS. 1-2 are exemplary, a person skilled in the art will understand that structural support 22 may take any shape suitable to hold nanotube blade 30.

According to an exemplary embodiment, structural support 22 secures nanotube blade 30 in a specified orientation. According to an exemplary embodiment, structural support 22 is a rigid body. Structural support 22 may be manufactured from any number of known materials according to any suitable method. Such a structure may include one or more nanotubes systematically arranged together. According to an alternative embodiment, structural support 22 is an elastic body. The elastic nature of structural support 22 may allow a predetermined flex within structural support 22 when nanotube blade 30 contacts the material. Allowing support structure 22 to flex prevents nanotube blade 30 from breaking after experiencing an increased load condition during a slicing operation.

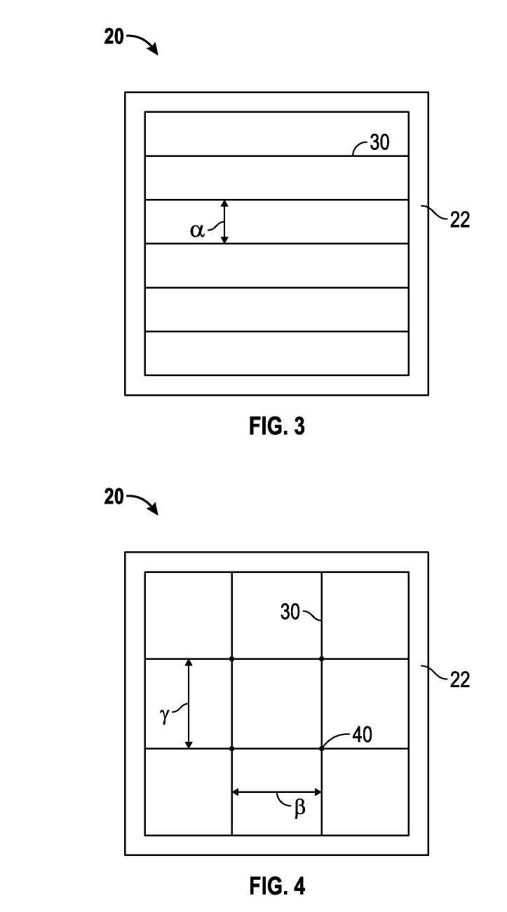

Referring next to FIGS. 3-4, nanotube slicer 20 may include a plurality of nanotube blades 30. While FIGS. 3-4 show nanotube blades 30 arranged in a specified pattern, nanotube blades 30 may also be arranged in a random array. According to the exemplary embodiment shown in FIG. 3, nanotube blades 30 are located within structural support 22. As discussed above, the shape of support structure 22 may be changed depending on the nature of the slicing operation performed, the shape of the surrounding equipment, or for another purpose. According to an exemplary embodiment, the ends of nanotube blades 30 are coupled to structural support 22. Structural support 22 may include a device configured to vary a characteristic (e.g., relative spacing, relative angle, tension, etc.) of nanotube blades 30. Such a device may include a hinge positioned at a corner of structural support 22 that allows portions of structural support 22 to move thereby facilitating the relative movement of nanotube blades 30. In other embodiments, the device may include motors, slide systems, or other mechanisms configured to vary a characteristic of nanotube blades 30.

As shown in FIG. 3, nanotube blades 30 are arranged parallel to one another. According to an exemplary embodiment, nanotube blades 30 are spaced at a distance α, which is approximately equal to a desired processed particle size (e.g., within 0.01 millimeters). Distance α or the configuration of structural support 22 may be specified in order to produce sliced material of a required uniform size. Such a required uniform size may be preferred, for example, to produce cement particles having a size of between 0.003 and 0.005 millimeters or gold particles having a size of between 0.01 and 0.05 millimeters. While such particles are traditionally produced using milling, nanotube blades 30 may also produce similarly sized particles where distance α is between 0.003 and 0.005 millimeters or between 0.01 and 0.05 millimeters, respectively. Still other materials (e.g., coal, iron ore, paint pigments, etc.) may be processed to similar or other sizes. According to still another alternative embodiment, nanotube blades 30 are arranged angularly offset from one another or structural support 22 at a specified angle.

Referring to the exemplary embodiment shown in FIG. 4 nanotube blades 30 are arranged in a rectangular array. As shown in FIG. 4, nanotube blades 30 are located within, and coupled to, structural support 22. As discussed above, the shape of support structure 22 may be changed depending on the nature of the slicing operation performed. According to an exemplary embodiment, nanotube blades 30 are arranged in a grid pattern. As shown in FIG. 4, nanotube blades 30 are spaced at a vertical distance γ and a lateral distance β relative to one another. Vertical distance γ and lateral distance β may be approximately equal to a desired processed particle size (e.g., within 0.01 millimeters). Distance γ, distance β, or the configuration of structural support 22 may be specified in order to produce sliced material of a preferred uniform size.

According to an exemplary embodiment, distance γ and distance β are between approximately 0.003 millimeters and 0.005 millimeters (e.g., to produce cement particles having a size of between 0.003 and 0.005 millimeters). According to an alternative embodiment, distance γ and distance β are between approximately 0.01 millimeters and 0.05 millimeters (e.g., to produce gold particles having a size of between 0.01 and 0.05 millimeters). According to still another alternative embodiment, nanotube blades 30 are arranged in another orientation (e.g., angularly offset from one another at a specified angle within the grid array). Arranging nanotube blades 30 in another orientation provides at least the benefit of producing processed material having a different shape than material processed by nanotube blades 30 arranged in a grid array. Such a shape may impact how the processed material responds to further processing. By way of example, cement particles may cure after different periods of time depending on the shape and surface area of the sliced cement particles.

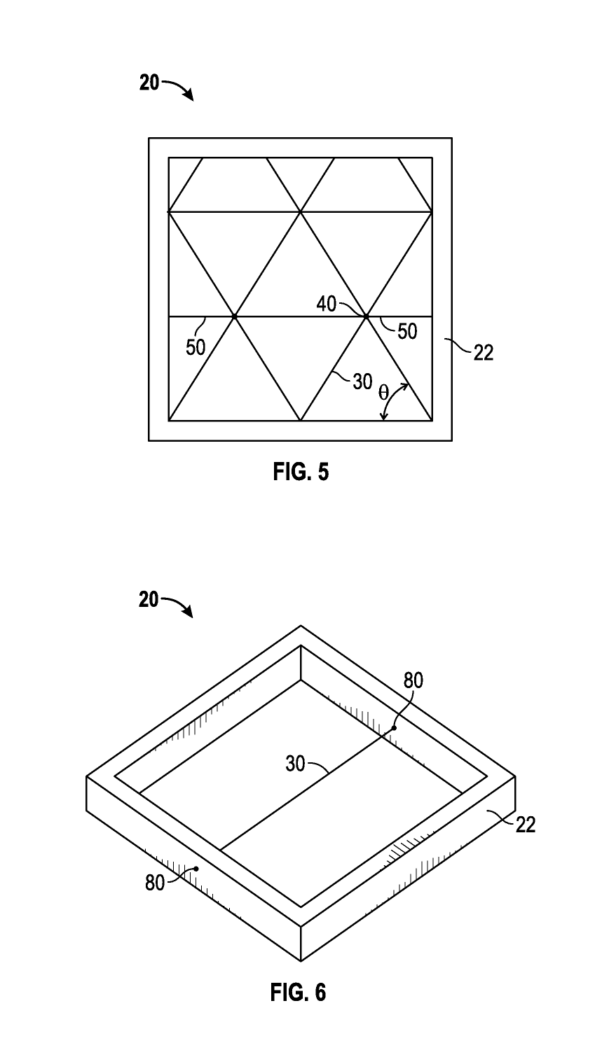

Referring next to FIG. 5, in an exemplary embodiment, nanotube blades 30 are arranged in a triangular array. According to the exemplary embodiment shown in FIG. 5, nanotube blades 30 are located within, and coupled to, structural support 22. As discussed above, the shape of support structure 22 may vary depending on the nature of the slicing operation performed. As shown in FIG. 5, nanotube blades 30 may be arranged in a triangular array pattern. Arranging nanotube blades 30 in a triangular array provides at least the benefit of slicing material into a uniform triangular shape. Such triangular shape may impact how the processed material responds to further processing (e.g., cement particles may cure after a different period of time depending on their shape). According to an exemplary embodiment, nanotube blades 30 are angularly offset relative to one another at an angle θ. Angle θ or the configuration of structural support 22 may be specified in order to produce sliced material of a preferred uniform size. According to an exemplary embodiment, angle θ is between approximately 0° and 90°. According to an exemplary embodiment, angle θ is 60° such that sides of triangles formed by nanotube blades 30 within the triangle array are approximately equal to one another. As shown in FIG. 5, the triangular array may include one or more laterally placed nanotube blades 50. Such laterally placed nanotube blades 50 may be molecularly identical to nanotube blades 30 or may have a molecular structure distinct from nanotube blades 30.

Referring to FIGS. 4-5, nanotube blades 30 may overlap one another to form an interface, shown as nodes 40. According to an exemplary embodiment, nanotube blades 30 overlap one another at nodes 40 without contacting one another. According to an alternative embodiment, nanotube blades 30 are coupled at nodes 40. Such coupling between nanotube blades 30 may take any known form, including overlapping contact between nanotube blades 30. According to an exemplary embodiment, nanotube blades 30 are woven together. According to an alternative embodiment, nanotube blades 30 are coupled at nodes 40 through twisting, tying, or molecular crosslinking. While these coupling methods are provided as examples, it should be understood that nanotube blades 30 may be coupled at nodes 40 using any suitable configuration of physical, chemical, or molecular processes. Coupling nanotube blades 30 at nodes restricts the relative movement of nanotube blades 30 and results in nanotube slicer 20 having different slicing characteristics. By way of example, fixing nanotube blades 30 at nodes 40 may reduce flexibility or prevent the material from overcoming the tensile strength of nanotube blade 30 during a slicing operation.

Referring again to FIGS. 3-5, in various exemplary embodiments, distances and angles between nanotube blades 30 are specified. According to an alternative embodiment, still other features of the nanotube blade pattern are specified (e.g., other relative distances or angles between nanotube blades 30, an offset distance between overlapping nanotube blades 30, etc.). Specifying relative features of nanotube blades 30 in nanotube slicer 20 allows for still greater control over the processed material, which provides the advantages discussed above.

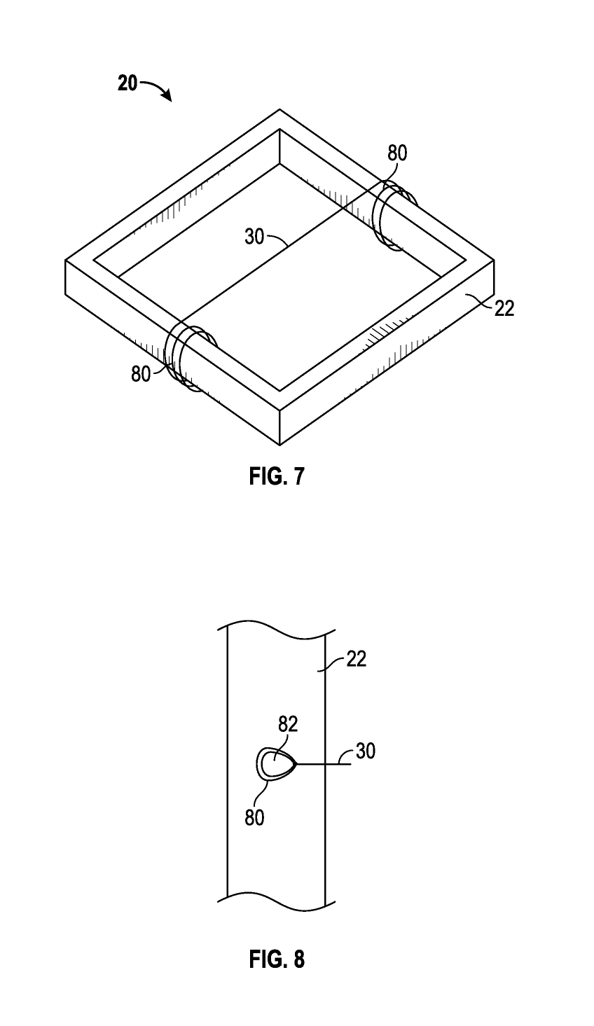

Referring next to FIGS. 6-7 nanotube slicer 20 includes a structural support 22 and one or more nanotube blades 30 coupled to structural support 22, according to an exemplary embodiment. Such coupling between nanotube blades 30 and structural support 22 may be accomplished chemically, molecularly, or physically, among other coupling techniques. According to the exemplary embodiment shown in FIG. 6, structural support 22 includes an interface, shown as mounting interface 80 that facilitates coupling nanotube blade 30 to structural support 22. According to an exemplary embodiment, mounting interface 80 is an aperture within structural support 22 configured to receive nanotube blade 30. According to an exemplary embodiment, nanotube blade 30 is pressed into mounting interface 80 in order to secure nanotube blade 30 within structural support 22. According to an alternative embodiment, nanotube blade 30 is secured within mounting interface 80 by an adhesive. While exemplary mounting techniques have been provided, nanotube element 30 may be secured within mounting interface 80 using a molecular connection or any other suitable means.

Referring to FIG. 7, nanotube blade 30 may be coupled to structural support 22 at interface 80 by wrapping, according to an alternative embodiment. As shown in FIG. 7, nanotube blade 30 is wrapped around at least a portion of structural support 22. Wrapping nanotube blade 30 around structural support 22 provides the benefit of securing nanotube blade 30 to structural support 22 without placing direct stress on structural support 22 through mounting interface 80 during a slicing operation. By way of example, a slicing operation increases the stress within nanotube blade 30. The increased stress is transferred from nanotube blade 30 to structural support 22 through mounting interface 80. Wrapping nanotube blade 30 around at least a portion of structural support 22 allows structural support 22 to more uniformly receive the increased stress at mounting interface 80. According to an alternative embodiment, mounting interface 80 includes an adhesive that further couples nanotube blade 30 to structural support 22. According to still another alternative embodiment, nanotube blade 30 is molecularly crosslinked at mounting interface 80.

Referring to FIG. 8, according to still another alternative embodiment, an end of nanotube blade 30 is coupled to an interface, shown as end assembly 82. As shown in FIG. 8, end assembly 82 secures nanotube blade 30 within mounting interface 80 and transfers loads from nanotube blade 30 into structural support 22. End assembly 82 may also distribute loads along a length of nanotube blade 30, reduce stress concentrations in nanotube blade 30 and structural support 22, and limit the likelihood that nanotube blade 30 will pull out of or slice through structural support 22. According to an exemplary embodiment, end assembly 82 includes a specified shape (e.g., a cylindrical pin having an axis transverse to nanotube blade 30; a conical, teardrop, or round shape; etc.) that is coupled (e.g., integrally formed, adhesively secured, molecularly linked, etc.) to an end of nanotube blade 30 at an interface. According to an exemplary embodiment, end assembly 82 is conical and coupled to nanotube blade 30 along an axis of the cone.

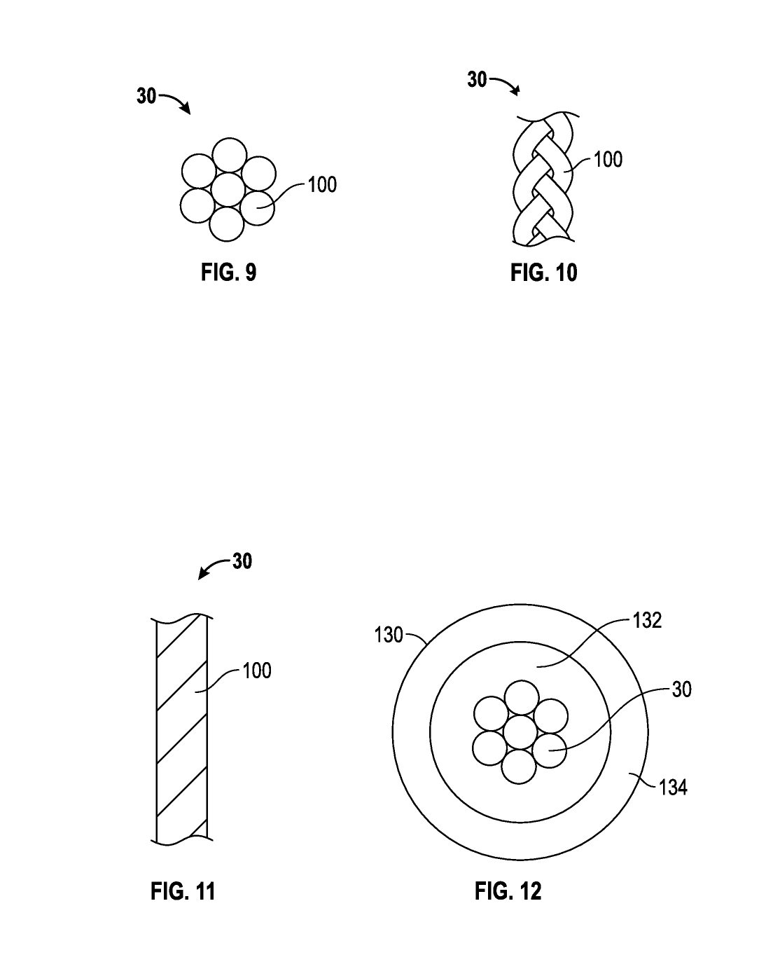

Referring to FIGS. 9-11, nanotube blade 30 may include one or more nanotube filaments 100, according to an exemplary embodiment. While exemplary configurations are shown in FIGS. 9-11, nanotube filaments 100 may be configured within nanotube blade 30 in still other patterns. According to the exemplary embodiment, nanotube blade 30 includes multiple nanotube filaments 100 arranged in a bundle. As shown in FIG. 9, nanotube filaments 100 within a bundle are arranged proximate to one another in an orderly manner.

According to the alternative embodiment shown in FIG. 10, nanotube blade 30 includes multiple nanotube filaments 100 braided together. A nanotube blade 30 having braided nanotube filaments 100 possesses different material properties than a nanotube blade 30 having nanotube filaments 100 arranged in a bundle. According to an exemplary embodiment, nanotube blade 30 includes three nanotube filaments 100 braided together. According to alternative embodiments, nanotube blade 30 may include a different number of nanotube filaments 100 braided together in a different manner.

According to the alternative embodiment shown in FIG. 11, nanotube blade 30 includes multiple nanotube filaments 100 twisted together to form a yarn. According to an exemplary embodiment, nanotube blade 30 includes two nanotube filaments 100 twisted together. According to alternative embodiments, nanotube blade 30 may include a different number of nanotube filaments 100 twisted together in a different manner. While examples of nanotube filaments 100 arranged into nanotube bundles, nanotube braids, and nanotube yarn are provided herein as examples, it should be understood that nanotube blade 30 may include nanotube filaments 100 arranged into other suitable configurations.

Nanotube blades having nanotube filaments configured in a pattern possesses different material properties than a single nanotube filament. Materials properties vary even among nanotube blades having nanotube filaments configured in different patterns. Such material properties that may vary are diameter, maximum length, density, tensile strength, hardness, ductility, and fatigue characteristics, among other properties.

By way of example, a single-walled nanotube filament may have a tensile strength of about 100 GPa whereas nanotube filaments arranged in a crosslinked bundle may have a tensile strength of about 17 GPa. By way of a further example, a single-walled nanotube filament may have a length of 0.185 meters. These properties allow nanotube blades to overcome the 100 MPa order of magnitude compressive strength of a material. By way of example, the ratio of the nanotube blade diameter to the material diameter may be between one hundred and one thousand. This aspect ratio allows a 1-10 micrometer diameter nanotube blade to cut a 0.001 meter piece of material. Given the relative compressive strength of the material being sliced and the tensile strengths of the nanotube filaments, the slicing pressure on the material may be approximately 0.1-1 GPa.

Referring to FIG. 12, nanotube blades 30 may include a coating 130. According to an exemplary embodiment, coating 130 is a single material (e.g., silicon carbide, boron nitride, a fluoropolymer, molybdenum disulfide, etc.). According to the alternative embodiment shown in FIG. 12, coating 130 may include multiple coating layers including a base layer 132 and an outer layer 134. Base layer 132 and outer layer 134 may have a specified thickness according to the demands of the slicing operation being performed. As shown in FIG. 12, base layer 132 and outer layer 134 at least partially surround nanotube blade 30. Coating 130 may be disposed proximate to at least one of nanotube blades 30 and nanotube filaments 100 according to any known technique. According to an exemplary embodiment, coating 130 is introduced through electroplating. According to various alternative embodiments, coating 130 is introduced through electroless deposition, vacuum deposition, chemical solution deposition, or another known technique.

According to the exemplary embodiment shown in FIG. 12, base layer 132 facilitates bonding between outer layer 134 and nanotube blade 30. According to an exemplary embodiment, outer layer 134 is a hard material designed to facilitate the slicing process. By way of example, such hard material may include silicon carbide, boron nitride, among others. According to an alternative embodiment, outer layer 134 is a relatively soft material designed to lubricate the slicing process. By way of example, such relatively soft materials include fluoropolymers, molybdenum disulfide, among others. Base layer 132 may be a material having a hardness greater than outer layer 134. By having a hardness greater than outer layer 134, base layer 132 prolongs the life of nanotube blade 30 by protecting the filaments in the event that outer layer 134 wears away.

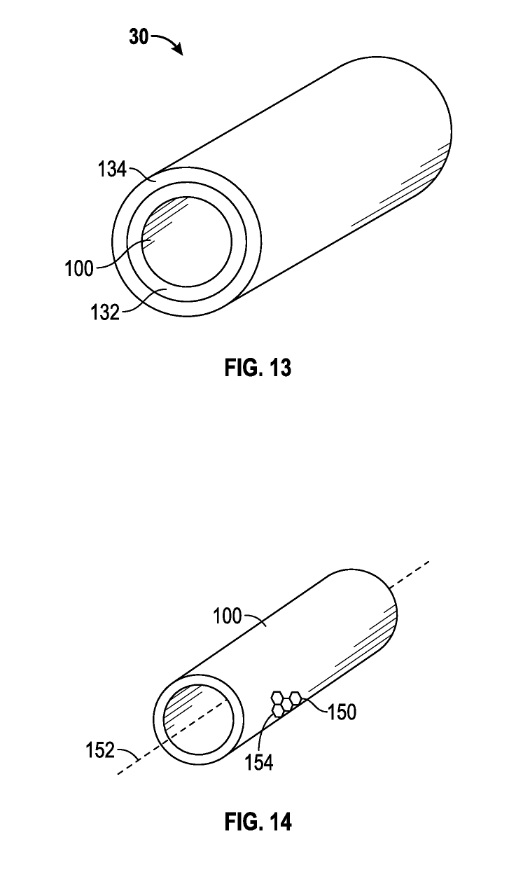

Referring to FIG. 13, nanotube blade 30 may include a single nanotube filament 100, which may be coated. According to an exemplary embodiment, the coating includes a single material. According to the alternative embodiment shown in FIG. 13, the coating includes multiple coating layers, such as a base layer 132 and an outer layer 134. Base layer 132 and outer layer 134 may have a preferred thickness relating to the demands of the slicing operation being performed. As shown in FIG. 13, base layer 132 and outer layer 134 at least partially surround nanotube filament 100.

According to the exemplary embodiment shown in FIG. 13, base layer 132 facilitates bonding between outer layer 134 and nanotube blade 30. According to an exemplary embodiment, outer layer 134 is a hard material designed to facilitate the cutting process. According to an alternative embodiment, outer layer 134 is a relatively soft material designed to lubricate the cutting process. Base layer 132 may be a material having a hardness greater than outer layer 134. By having a hardness greater than outer layer 134, base layer 132 prolongs the life of nanotube filament 100 by protecting the filament should outer layer 134 wear away.

While FIGS. 12-13 show nanotube blade 30 or nanotube filament 100 having a coating 130, it should be understood that any combination of nanotube filaments 100 and nanotube blades 30 may include coating 130. According to an exemplary embodiment, at least one of nanotube filaments 100 within nanotube blade 30 includes coating 130 and nanotube blade 30 includes coating 130. According to an alternative embodiment, at least one nanotube filament 100 includes coating 130, and nanotube blade 30 does not include coating 130. According to an alternative embodiment, nanotube filament 100 does not include coating 130 and nanotube blade 30 includes coating 130. In other words, it is possible to take the independently coated nanotube filaments 100, as shown in FIG. 13, and arrange the coated nanotube filaments into a nanotube bundle, braid, or yarn. It is also possible to coat nanotube blade 30 partially or entirely after the coated or uncoated nanotube filaments 100 have been arranged into a nanotube bundle, braid or yarn. According to still another alternative embodiment, neither nanotube filaments 100 nor nanotube blades 30 include coating 130.

Referring again to FIGS. 12-13, coating 130 may include a number of known materials. According to an exemplary embodiment, at least one of base layer 132 and outer layer 134 are selected to facilitate slicing a material. Both hard and soft materials facilitate slicing material in different ways. Hard materials may act as an abrasive and directly contribute to slicing the material. Such hard materials include silicon carbide, boron nitride, and other abrasive materials. Soft materials may serve to lubricate the slicing action between nanotube blade 30 and the material. Soft materials may also protect nanotube blades 30 or filaments 100 during handling. Soft materials may also facilitate relative slip between nanotube filaments 100 or nanotube blades 30. Such soft materials include fluoropolymers, molybdenum disulfide, and other lubricating materials.

Referring again to FIGS. 9-11, nanotube filaments 100 may be coupled to one another within the bundle, braid or yarn. According to an exemplary embodiment, nanotube filaments 100 contact one another. In this arrangement, nanotube filaments 100 are able to slip relative to one another. According to an alternative embodiment, nanotube filaments 100 are fixed to one another. Such coupling between nanotube filaments 100 may be achieved using any available process. By way of example, nanotube filaments 100 may be chemically bonded using an adhesive, molecularly crosslinked, or coupled using another process.

According to an exemplary embodiment, coupling nanotube filaments 100 within each nanotube blade 30 restricts the relative movement of the nanotube filaments and varies the characteristics of nanotube blade 30. By way of example, fixing nanotube filaments 100 together provides a more rigid nanotube blade 30 and facilities direct stress transfer between nanotube filaments 100 upon contact with the material. By allowing relative movement between nanotube filaments 100, nanotube filaments 100 that contact the material first may deform or move before transferring the stress to other, non-contacting nanotube filaments 100.

Referring to FIG. 14, the molecular structure of nanotube filament 100 is shown, according to an exemplary embodiment. As shown in FIG. 14, nanotube filament 100 is a single-walled nanotube having base atoms 150. Base atoms 150 are arranged in a tubular matrix shell. According to an exemplary embodiment, nanotube filament 100 includes a hemispherical cap (not shown) at one or both ends of the tubular lattice. Nanotube filament 100 includes a tube axis 152, an armchair line, a chiral vector (not shown), and a wrapping angle (not shown) formed between the chiral vector and the armchair line. According to an alternative embodiment, nanotube filament 100 comprises a multi-walled nanotube filament. While single-walled nanotubes may have a greater tensile strength, multi-walled nanotubes may offer manufacturing advantages or improve the tensile strength, thickness, or other features of a nanotube blade.

The chiral vector determines a chirality, or twist, of nanotube filament 100. Chirality affects the material properties of nanotube filament 100 including density, lattice structure, and conductance, among other properties. According to an exemplary embodiment, the chirality of nanotube filament 100 is controlled to enhance the conductivity of nanotube filament 100. According to an alternative embodiment, the chirality of nanotube filaments 100 is not controlled, which results in nanotube filaments 100 having random chiralities where two-thirds of nanotube filaments 100 are semi-conducting and the remaining one-third are conductive.

Other material properties of nanotube filaments 100 may also be important to the design of nanotube slicer 20. For example, the density of nanotube filaments 100 may impact the weight per unit length of nanotube filament 100, which may impact the production costs of nanotube filaments 100. The density of nanotube filaments 100 is also important to the design of the nanotube slicer 20 because nanotube filaments 100 having an insufficient density may have a tendency to break during the slicing process or may cut less efficiently than nanotube filaments 100 having a preferred density.

Referring again to FIG. 14, base atoms 150 are arranged in a matrix. According to an exemplary embodiment, base atoms 150 are carbon. According to an alternative embodiment, base atoms 150 are boron nitride. As shown in FIG. 14, nanotube filament 100 includes base atoms 150 located at the hexagonal points and bonds 154 represented by the sides of each hexagon. While FIG. 14 shows a single nanotube filament 100 with base atoms 150 bonded only to other base atoms 150 within nanotube filament 100, it should be understood that crosslinking between nanotube filaments 100 may be specified or occur indirectly. Crosslinking occurs where bonds form between base atoms 150 of two nanotube filaments 100. As discussed above, this cross-linking affects the material properties of each independent nanotube filament 100 and also the properties of nanotube filaments 100 collectively. By way of example, crosslinked nanotube filaments 100 may transfer stress more directly or efficiently than non-crosslinked nanotube filaments. Crosslinking also limits the relative movement between nanotube filaments 100 as the crosslinked bonds must be broken before the nanotube filaments may slip relative to one another.

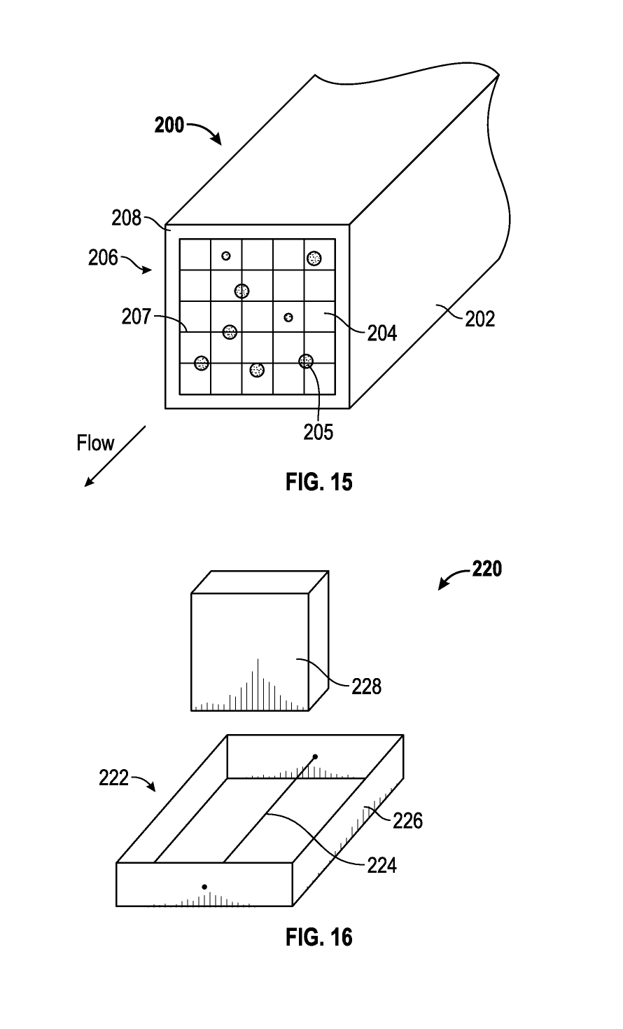

Referring next to FIGS. 15-23, nanotube slicers may be utilized in various applications. Specifically, nanotube slicers may be utilized to reduce the size of material, extract material from a ground volume, or section material samples already removed from a ground volume. In still other embodiments, nanotube slicers may be used as a sampling tool in a borehole assembly unit.

Referring first to FIG. 15, a reducing system, shown as nanotube slicer 200 may replace or supplement the use of traditional milling machines. As discussed above, nanotube slicer 200 may reduce the size of a received material (e.g., a mineral, ore, paint, cement, etc.) initially measuring less than one centimeter to a preferred dimension. By way of example, nanotube slicer 200 may produce fine-scale cement powder from small particles. Such slicing may reduce the cement powder in size by the factor of between three and ten.

As shown in FIG. 15, nanotube slicer 200 includes a channel, shown as housing 202. According to an exemplary embodiment, housing 202 is a tubular structure configured to receive a fluid flow. Such a fluid flow may be generated by a driver (e.g., pump, blower, gravity head, etc.) and configured to travel through housing 202. According to an exemplary embodiment, the fluid flow is not pressurized, and housing 202 includes at least one exposed portion. In either embodiment, a fluid flow, shown as fluid 204 in FIG. 15, may be disposed within housing 202. According to an exemplary embodiment, fluid 204 is a liquid. According to an alternative embodiment, fluid 204 is a gas.

Referring again to FIG. 15, nanotube slicer 200 also includes a slicer, shown as slicing element 206, which includes a plurality of slicing blades, shown as nanotube blades 207. While FIG. 15 shows a plurality of nanotube blades 207 arranged in a grid array, it should be understood that nanotube slicer 200 may incorporate the various orientations of nanotube blades, coatings, and coupling systems discussed above. As shown in FIG. 15, nanotube blades 207 have ends coupled to a structural member, shown as support 208. According to an exemplary embodiment, support 208 is releasably coupled to housing 202 and positioned perpendicular to a flow of fluid 204. According to an alternative embodiment, nanotube support 208 may be otherwise coupled to housing 202 or nanotube slicer 200 may not include a support 208.

According to an exemplary embodiment, material, shown as particles 205 may be located (i.e. suspended, disposed, etc.) within fluid 202. In embodiments where fluid 202 is flowed through housing 202, particles 205 also move along housing 202 at a velocity. As fluid 204 flows through slicing element 206, smaller particles 205 (e.g., those having a size smaller than the spacing between nanotube blades 207) flow through slicing element 206 and continue along housing 202 while other particles 205 (e.g., those having a size larger than the spacing between nanotube blades 207, smaller particles that nonetheless impact nanotube blades 207, etc.) may be moved into cutting engagement with nanotube blades 207 (i.e. the particles may impact nanotube blades 207 and nanotube blades 207 may slice, divide, split, partition, fragment, section, part, cut, deform, pass through, etc. the particles). According to an exemplary embodiment, nanotube blades 207 have a tensile strength that is greater than the compressive strength of the material. Such a nanotube blade 207 may slice through particles 205 to form two or more smaller pieces of material.

In some embodiments, slicing element 206 remains stationary while slicing the material particles. In other embodiments, slicing element 206, at least one nanotube blade 207, or another portion of nanotube slicer 200 may move (i.e. translate, oscillate, etc.). Such movement may occur in a direction that is transverse to the fluid flow direction. According to an exemplary embodiment, the movement causes cutting engagement between nanotube blades 207 and the particles to, by way of example, further reduce the size of elongated particles (e.g., columns, pillars, etc.). Such elongated particles may have a size that is larger than a preferred size while having a cross section that allows them to pass through nanotube blades 207. According to an alternative embodiment, nanotube slicer 200 may include two slicing elements 206. In some embodiments, at least one of the two slicing elements 206 may be configured to move to facilitate the slicing of the material particles. According to still another alternative embodiment, other configurations of nanotube blades may further reduce the size of the material particles (e.g., a drum of nanotube blades, a single moving nanotube blade, etc.).

Referring next to FIG. 16, nanotube slicer 220, according to an exemplary embodiment, includes a slicer, shown as slicing element 222 having a nanotube blade, shown as nanotube blade 224. As shown in FIG. 16, nanotube blade 224 includes ends coupled to a structural member, shown as support 226. While FIG. 16 shows a single nanotube blade 224 arranged within support 226, it should be understood that nanotube slicer 220 may incorporate the various orientations of nanotube blades, coatings, and coupling systems discussed above.

As shown in FIG. 16, nanotube slicer 220 includes a contacting device, shown as driver 228 configured to facilitate interaction between material and nanotube blade 224. According to an exemplary embodiment, driver 228 facilitates interaction by forcing nanotube blade 224 into the material. According to an alternative embodiment, driver 228 forces material into nanotube blade 224. As discussed above, the tensile strength of nanotube blade 224 may be greater than the compressive strength of the material thereby allowing nanotube blade 224 to slice through the material. Cutting engagement between nanotube blade 224 and material slices the material into two or more pieces. According to an exemplary embodiment, support 226 is coupled to driver 228. According to an alternative embodiment, nanotube blades 224 are coupled to driver 228.

Referring again to FIG. 16, driver 228 may include be any device capable of facilitating interaction between material and nanotube blade 224. According to an exemplary embodiment, driver 228 interacts physically with the material and includes a thrower configured to move the material into nanotube blade 224 or nanotube blade 224 into the material. According to an alternative embodiment, driver 228 is a press configured to force the material downward through support 226 and into nanotube blade 224. Such a driver 228 may include an actuator (e.g., a hydraulic cylinder, a screw, an electric motor etc.) configured to force an interfacing portion (e.g., a flat plate) into the material and drive the material through slicing element 222. Such a nanotube slicer 220 may operate in a control mode (e.g., indexed, continuous, etc.) where material is fed into and over nanotube blade 224. According to an exemplary embodiment, the interfacing portion is lowered to apply a force to the material. As a result, the material may be sliced into at least two pieces and material having a reduced size may fall through the bottom of slicing element 222. According to an alternative embodiment, physical interaction between the material and nanotube blade 224 may be facilitated by rollers or another known system.

According to still another alternative embodiment, driver 228 is a magnet configured to magnetically interact with the material. A magnetic driver 228 may cause cutting engagement between the material (e.g., iron ore particles, etc.) and the nanotube blade 224. The magnet may be a permanent magnet, an electromagnet, or any combination thereof. While exemplary embodiments of driver 160 are provided, it should be understood that driver 160 may be any combination of the devices listed above or still other suitable devices capable of causing cutting engagement between the material and nanotube blade 224.

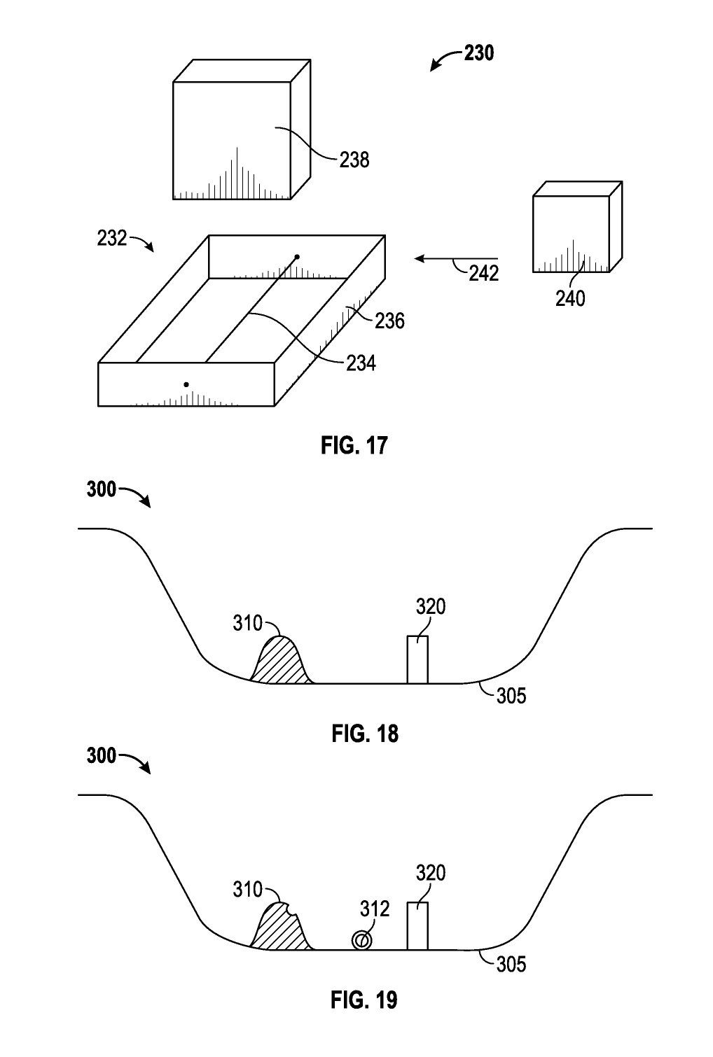

Referring next to the exemplary embodiment shown in FIG. 17, a slicer, shown as nanotube slicer 230 that includes a slicing element 232 having a nanotube blade, shown as nanotube blade 234. As shown in FIG. 17, nanotube blade 234 includes ends coupled to a structural member, shown as support 236. While FIG. 17 shows a single nanotube blade 234 arranged within support 236, it should be understood that nanotube slicer 230 may incorporate the various orientations of nanotube blades, coatings, and coupling systems discussed above.

As shown in FIG. 17, nanotube slicer 230 includes a contacting device, shown as driver 238 configured to facilitate interaction between material and nanotube blade 234. According to the exemplary embodiment shown in FIG. 17, nanotube slicer 230 includes an energy transfer device, shown as heater 240. In some embodiments, heater 240 facilitates the slicing operation of nanotube slicer 230 at least in part by softening the material. As shown by arrow 242 in FIG. 17, heater 240 transfers energy into nanotube blade 230. According to an exemplary embodiment, this heat is then transferred into the material to facilitate the slicing operation of nanotube slicer 230. According to an alternative embodiment, heater 240 may transfer energy into a coating disposed along nanotube blade 234. Such a coating (e.g., a vapor deposited tungsten) may be resistively or otherwise heated. According to still another alternative embodiment, heater 240 is configured to transfer energy into both nanotube blade 230 and a coating disposed along nanotube blade 230. Referring again to FIG. 17, the heat transfer as shown by arrow 242 may occur directly into nanotube blade 234 or indirectly through structural support 236.

Heater 240 may transfer energy into nanotube blade 234 using any suitable heat transfer process. According to an exemplary embodiment, heater 240 is an electrical inductance heater. According to an alternative embodiment, heater 240 is an electrical resistance heater, a system using radiation heat transfer, or a system using convection heat transfer. It should be understood that these heaters are exemplary and that heater 240 may be any known device capable of transferring energy into nanotube blade 234 and ultimately into the material. Where heater 240 relies on electrical interaction with either the structural support or the nanotube blade, the chirality of the nanotube filaments within nanotube blade 234 may be controlled as discussed above to facilitate energy transfer. According to an exemplary embodiment, the magnitude, angle, or both of the chiral vector is controlled in order to make the nanotube filaments more conductive. While this discussion illustrated that nanotube slicer 230 includes an energy transfer device, according to an exemplary embodiment, other nanotube slicers discussed herein may also include an energy transfer device to facilitate the slicing operation of the nanotube slicer.

Referring next to the exemplary embodiment shown in FIGS. 18-19, a nanotube slicer may be used to remove material from a ground deposit (e.g., for further processing using traditional machines or using the nanotube slicers discussed above). As shown in FIGS. 18-19, a mine, shown as material processing facility 300, includes a volume of material (e.g., gold, another metal, shale, cement, ore, coal, etc.), shown as deposit material 310 and a slicing device, shown as nanotube slicer 320. According to an exemplary embodiment, nanotube slicer 320 is utilized within material processing facility 300 to remove deposit material 310 from a ground surface, shown as ground interface 305 to produce a removed portion of material, shown as material sample 312. According to an alternative embodiment, material sample 312 is also partially removed from deposit material 310 using a traditional method such as blasting, drilling, sawing, or any other suitable technique. Those skilled in the art will understand that material processing facility 300 may also contain equipment to handle or transport material sample 312.

Referring again to FIGS. 18-19, deposit material 310 is subterranean, according to an exemplary embodiment. According to an alternative embodiment, deposit material 310 may be located at or above ground level. According to the exemplary embodiment shown in FIGS. 18-19, deposit material 310 is shown as protruding from the bottom of ground interface 305. According to an alternative embodiment, deposit material 310 is partially surrounded by ground interface 305. According to still another alternative embodiment, deposit material 310 is entirely surrounded or covered by ground interface 305.

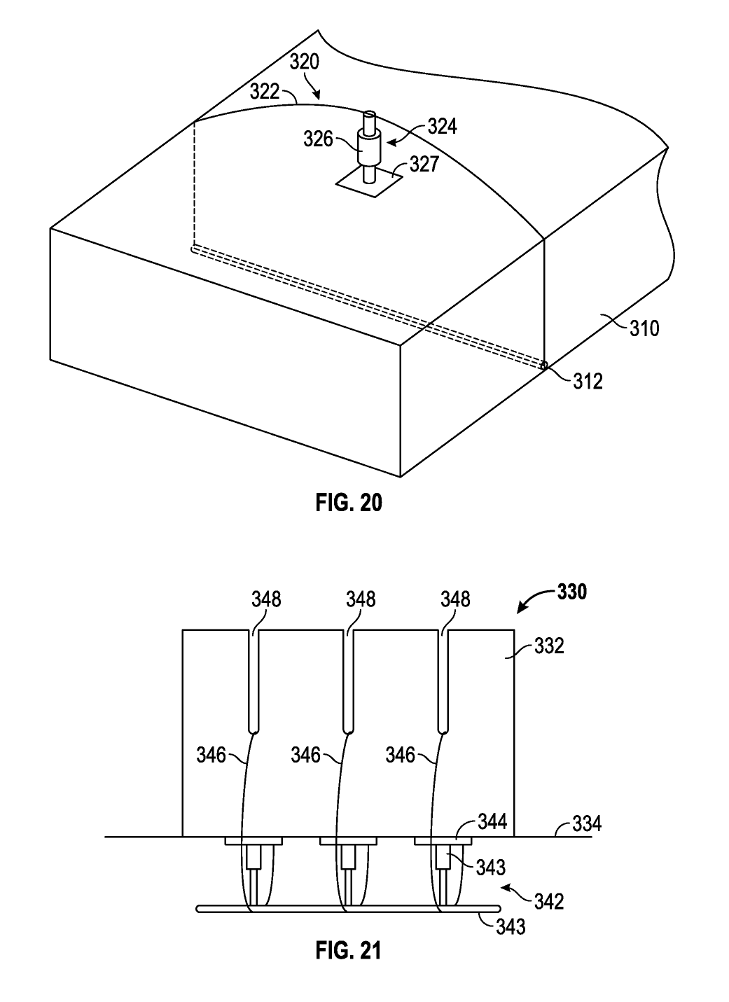

Referring next to the exemplary embodiment shown in FIG. 20, a slicer, shown as nanotube slicer 320 is utilized to remove a portion of material from deposit material 310. As shown in FIG. 20, nanotube slicer 320 may augment or replace the use saws or other machines traditionally utilized to remove portions of material from a ground deposit. By way of example, rope saws (i.e. wire saws, etc.) are traditionally fed through holes and rotated by a motor system to saw through the deposit. While slicing material 310 with nanotube slicer 320 has been discussed, it should be understood that nanotube slicer 320 may similarly slice through other materials (e.g., other rock, overburden, organic materials, etc.).

As shown in FIG. 20, a nanotube blade, shown as nanotube blade 322 is fed through a hole, shown as aperture 312, that is cut through deposit material 310. Such an aperture 312 may be formed through one or more drilling operations, according to an exemplary embodiment. It should be understood that various configurations of holes may be drilled or otherwise defined within deposit material 310 to receive nanotube blade 322 and thereby allow for the removal of material positioned underground, having a different shape, or positioned adjacent to other sections of ground or material.

Referring still to the exemplary embodiment shown in FIG. 20, nanotube slicer 320 includes a driver, shown as driver 324 configured to force (e.g., pull, draw, etc.) nanotube blade 322 through deposit material 310. Such a driver 324 may include various known systems such as a hydraulic cylinder, a pneumatic cylinder, and a track system having a motor positioned along side a deposit to pull the nanotube blade through the material, among others. As shown in FIG. 20, driver 324 includes a hydraulic cylinder, shown as actuator 326 having an end that is coupled to nanotube blade 322. According to an exemplary embodiment, nanotube blade 322 is wrapped around a portion of driver 324 (e.g., wrapped entirely around, received over a sheave, etc.). According to an alternative embodiment, nanotube blade 322 includes ends that are coupled to driver 324 (e.g., adhesively secured, pressed into, with cross linking, with an end assembly, etc.). According to still another alternative embodiment, nanotube blade 322 may otherwise interface with driver 324 (e.g., as a loop, not as a loop, etc.). As shown in FIG. 20 driver 324 also includes a force distribution system, shown as load plate 327, coupled to an end of actuator 326 and configured to distribute the opposing forces into a portion of deposit material 310.

As shown in FIG. 20, nanotube slicer 320 is supported by deposit material 310 and draws nanotube blade 322 upward to perform a slicing operation. According to an alternative embodiment, nanotube slicer may have a driver otherwise positioned (e.g., to the side of deposit material 310, along an underground face of deposit material 310, etc.). According to still another alternative embodiment, nanotube slicer 320 is supported by a surrounding ground surface or configured to otherwise force nanotube blade 322 through deposit material 310 (e.g., downward, to a side, etc.). In yet another alternative embodiment, the nanotube slicer may be used to slice another material (e.g., a bridge pylon, a bridge road surface, etc.). Such a nanotube slicer may include an interface (e.g., plate, surface, etc.) configured to engage the material.

According to an exemplary embodiment, driver 324 is controlled to cyclically increase the tension within nanotube blade 322 and thereafter decrease the tension within nanotube blade 322. Such an action cyclically applies and removes a slicing force upon ground material 310 (i.e. similar to the cyclic drilling action of a hammer drill), which may improve the speed that nanotube blade 322 slices through ground material 310. Nanotube blade 322 may be moved (e.g., rotated, translated along, etc.) relative to ground material 310 or another material sample during the low-tension portion of the cyclic loading. Such movement of nanotube blade 322 may be important where, by way of example, a coating (e.g., an abrasive, a lubricant, etc.) or the nanotube filaments are worn during slicing. While movement during a low-tension portion of the cyclic loading has been described, it should be understood that nanotube blade 322 may be moved during high-tension loading or during constant loading. According to an alternative embodiment, driver 324 applies a constant force to nanotube blade 322.

According to still another alternative embodiment, a nanotube slicer may be utilized to slice a material sample (e.g., a block, paving stones, counter top material, etc.) into two or more pieces or to a specified depth. By way of example, a nanotube slicer may section a material sample into various subsections having a preferred width. According to an exemplary embodiment shown in FIG. 20, nanotube slicer 320 may be also used to section a material sample. In such a configuration, nanotube blade 322 of nanotube slicer 320 may be fed through a hole defined within the material sample or may be initially wrapped around a material sample.

According to the alternative embodiment shown in FIG. 21, a slicer, shown as nanotube slicer 330 includes a material, shown as material sample 332 positioned on a support, shown as surface 334. As shown in FIG. 21, nanotube slicer 330 includes a plurality of drivers, shown as drivers 342, configured to slice material sample 332 with a nanotube blade, shown as nanotube blade 346. According to an exemplary embodiment, nanotube slicer 330 includes three drivers 342 and nanotube blades 346. According to an alternative embodiment, nanotube slicer 330 includes more or fewer drivers or nanotube blades.

According to the exemplary embodiment shown in FIG. 21, nanotube slicer 330 includes a coupler, shown as structural element 343, extending between and coupling the movement of drivers 342. By way of example, structural element 343 may promote even slicing of material sample 332. According to an alternative embodiment, nanotube slicer 330 does not include a structural element but includes another system designed to promote even slicing of material sample 332 (e.g., a control system for regulating the position of drivers 342 or the tension within nanotube blades 346). According to still another alternative embodiment, nanotube slicer 330 may slice material sample 332 unevenly.

Referring still to the exemplary embodiment shown in FIG. 21, driver 342 comprises a hydraulic cylinder, shown as actuator 343. Actuator 343 includes a first end coupled to structural element 343 (e.g., adhesively secured, pressed into, etc.) and a second end coupled to a load distribution system, shown as plate 344. According to an exemplary embodiment, plate 344 is coupled to surface 334 such that loads from driver 342 are transferred into surface 334. According to an alternative embodiment, plate 344 may directly interface with material sample 332 or driver 342 may directly interface with material sample 332, among other potential alternatives. As shown in FIG. 21, actuators 343 are configured to extend downward and draw nanotube blade 346 at least partially through material sample 332. It should be understood that actuators 343 may further extend to force nanotube blade 346 entirely through material sample 332.

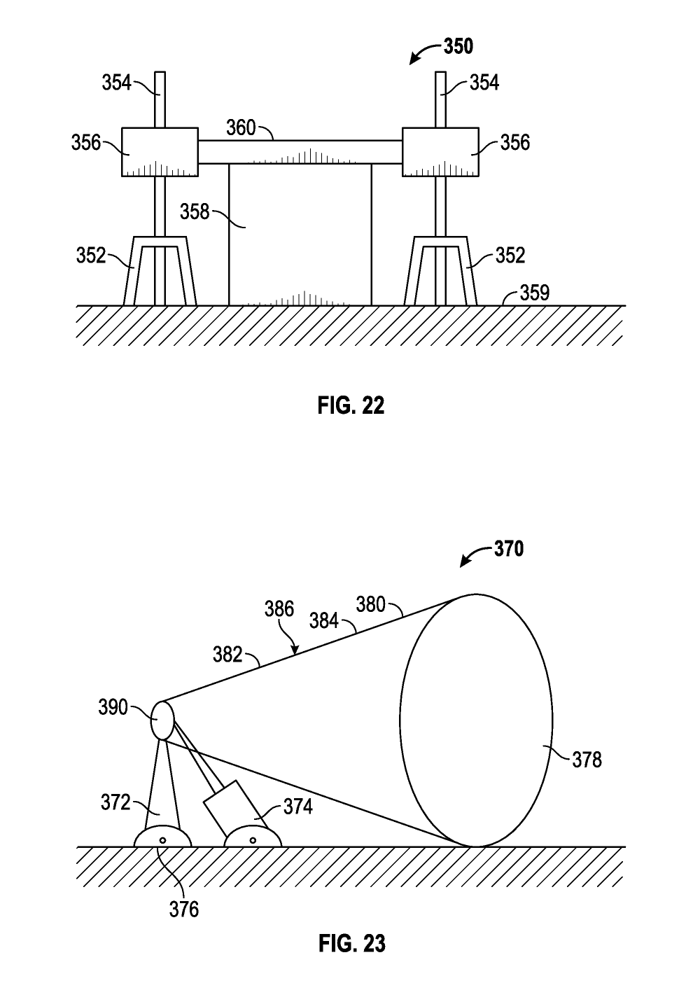

Referring next to the exemplary embodiment shown in FIG. 22, a slicer, shown as nanotube slicer 350, includes support, shown as frames 352 and support bars, shown as guides 354. As shown in FIG. 22, frames 352 are disposed on opposing sides of a volume of material, shown as material sample 358 and coupled to a ground surface, shown as support surface 359. According to an exemplary embodiment, guides 354 are each coupled to a support 352 and to support surface 359. According to an alternative embodiment, guides 354 may be coupled only to frames 352, guides 354 may be coupled to material sample 358, or nanotube slicer 350 may not include frames 352.

According to an exemplary embodiment, nanotube slicer 350 includes drive mechanisms, shown as drivers 354 disposed along guides 354. According to an alternative embodiment, nanotube slicer 350 includes only one driver 356 (e.g., a non-driving guide sheave may be positioned along the opposing guide 354, nanotube slicer 350 may have only one frame 352 and guide 354, etc.). As shown in FIG. 22, drivers 354 include a rotational motor configured to engage guides 354 (e.g., with a toothed connection) and move vertically along material sample 358. According to an alternative embodiment, drivers 354 include an actuator, a winch system, or another device.

As shown in FIG. 22, nanotube slicer 350 includes a nanotube slicing element, shown as nanotube blade 360. According to an exemplary embodiment, nanotube blade 360 includes one or more nanotube filaments arranged into a bar and having ends coupled to drivers 356. As shown in FIG. 22, nanotube blade 360 may be initially positioned above material sample 358. According to an exemplary embodiment, drivers 356 engage guides 354 and force nanotube blade 360 through at least a portion of material sample 358. According to an alternative embodiment, drivers 356 may travel downward to support surface 359 to slice entirely through material sample 358.

Referring next to the alternative embodiment shown in FIG. 23, a nanotube slicer, shown as nanotube slicer 370 includes a frame, shown as support 372 and a force mechanism, shown as actuator 374. As shown in FIG. 23, support 372 and actuator 374 each include a first end rotatably coupled to a surface, shown as support surface 376. According to an exemplary embodiment, actuator 374 includes a second end coupled to support 372. As shown in FIG. 23, actuator 374 is initially angled relative to support surface 376. According to an alternative embodiment, actuator 374 or support 372 may be otherwise positioned.

As shown in FIG. 23, nanotube slicer 370 includes a nanotube element, shown as nanotube blade 380 arranged in a nanotube loop. According to an exemplary embodiment, nanotube blade 380 includes a first end 382 and a second end 384 joined together at union 386. According to an exemplary embodiment, union 386 is formed by physically joining first end 382 and second end 384. According to an alternative embodiment, union 386 is formed by tying first end 382 to second end 384. According to still another alternative embodiment, union 386 is formed by joining first end 386 and second end 384 chemically or molecularly (e.g., with cross linking).

Referring again to FIG. 23, nanotube blade 380 is initially positioned around a volume of material, shown as material sample 378. According to an exemplary embodiment, nanotube slicer 370 also includes a driver, shown as drive system 390. As shown in FIG. 23, nanotube blade 380 is also coupled to drive system 390. According to an alternative embodiment, first end 382 and second end 384 of nanotube blade 380 may be coupled to drive system 390 (e.g., adhesively secured, pressed into, with cross linking, with an end assembly, etc.). Drive system 390 may rotate nanotube blade 380 to, for example, re-apply a coating to nanotube blade 380. Such a coating may be an abrasive configured to contribute to the slicing process or a soft material configured to lubricate the slicing operation of nanotube blade 380. According to an exemplary embodiment, drive system 390 includes a storage volume containing the coating and an applicator configured to distribute the coating onto nanotube blade 380 as it rotates along drive system 390.

In operation, according to an exemplary embodiment, nanotube blade 380 may begin wrapped around a portion of material sample 378 and drive system 390. According to an exemplary embodiment, actuator 374 extends outward thereby rotating support 372 and applying a tensile force to nanotube blade 380. Actuator 374 may apply a still greater force until nanotube blade 380 begins to pull through material sample 378. According to an exemplary embodiment, drive system 390 may rotate nanotube blade 380. In some embodiments, nanotube blade 380 is rotated but not cycled (i.e. rotated entirely around material sample 378). Such rotation may facilitate the slicing operation of nanotube slicer 370.

According to an alternative embodiment, actuator 374 may apply a force to pull nanotube blade 380 a distance through material sample 370 and thereafter retract to reduce or eliminate the force imparted by nanotube blade 380 onto material sample 370. In such a reduced-tension state, drive system 390 may re-coat nanotube blade 380 by rotating nanotube blade 380 along the applicator of drive system 390. Actuator 374 may thereafter again apply a force to pull nanotube blade 380 through material sample 378. Such a process may be repeated until nanotube blade 380 passes through a portion of or entirely through material sample 378. According to an alternative embodiment, drive system 390 may rotate nanotube blade 380 as actuator 374 applies a slicing force. While this discussion focused on nanotube slicer 370 having a drive system 390 and an applicator to re-coat a nanotube blade, the other nanotube slicers discussed herein may similarly include such systems.

According to an exemplary embodiment, a nanotube slicer may include a load sensor configured to monitor the tension within the nanotube blade. Such a load sensor may be coupled along the nanotube blade, or the nanotube blade may have ends coupled (e.g., adhesively secured, pressed into, with cross linking, with an end assembly, etc.) to the load sensor. Such a load sensor may communicate the tension in the nanotube blade to a controller configured to regulate the application of a slicing force. By way of example, the controller may monitor the amount of force applied by a hydraulic cylinder or another driver to prevent damage to the nanotube blade. Such a system may operate automatically or manually (i.e. with or without input from an operator). According to an exemplary embodiment, the tension within the nanotube blade may be adjusted initially, continuously during the slicing operation, or both. Nanotube blades may operate with a specified amount of slack or may be under preload tension depending on the cutting conditions experienced.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A device for slicing material, comprising:
a structural support; and
a nanotube blade comprising a nanotube filament having atoms arranged in a lattice structure and having a first end and a second end, wherein both the first end and the second end are coupled to the structural support and separated by a length of the nanotube blade.

2-12. (canceled)

13. The device of claim 1, further comprising a plurality of overlapping nanotube blades arranged in a rectangular array with a specified array spacing, the rectangular array forming a node.

14. The device of claim 13, wherein the plurality of overlapping nanotube blades are coupled at the node.

15. The device of claim 14, wherein the plurality of overlapping nanotube blades are woven together.

16. The device of claim 14, wherein the plurality of overlapping nanotube blades are twisted or otherwise tied at the node.

17. The device of claim 14, wherein the plurality of overlapping nanotube blades are molecularly crosslinked at the node.

18. (canceled)

19. The device of claim 13, wherein the structural support further includes at least one aperture configured to receive the nanotube blade.

20. The device of claim 13, wherein the nanotube blade is wrapped around at least a portion of the structural support.

21-28. (canceled)

29. The device of claim 1, the nanotube blade further comprising a coating at least partially surrounding the nanotube filament.

30. The device of claim 29, wherein the coating is a silicon carbide.

31-33. (canceled)

34. The device of claim 1, the nanotube blade further comprising a plurality of nanotube filaments, wherein the plurality of nanotube filaments are arranged into a nanotube bundle.

35. The device of claim 34, the nanotube blade further comprising a coating at least partially surrounding the nanotube blade.

36-39. (canceled)

40. The device of claim 34, wherein at least one nanotube filament is molecularly crosslinked to another nanotube filament.

41. The device of claim 1, the nanotube blade further comprising a plurality of nanotube filaments, wherein the plurality of nanotube filaments are arranged into at least one of a nanotube braid and a nanotube yarn.

42. The device of claim 41, the nanotube blade further comprising a coating at least partially surrounding the nanotube filaments.

43-46. (canceled)

47. The device of claim 41, wherein at least one nanotube filament is molecularly crosslinked to another nanotube filament.

48. The device of claim 1, further comprising an adjuster configured to vary the tension on the nanotube blade.

49. The device of claim 48, wherein the nanotube filament is under a preload tension.

50-54. (canceled)

55. A device for reducing the size of a material particle, comprising:
a slicer, the slicer comprising:
a structural support; and
a nanotube blade comprising a nanotube filament having atoms arranged in a lattice structure and having a first end and a second end, wherein both the first end and the second end are coupled to the structural support and separated by a length of the nanotube blade; and
a driver configured to move the material particle into cutting engagement with the slicer.

56. The device of claim 55, wherein the driver is configured to force cutting engagement between the material particle and the nanotube blade and comprises:
a press coupled to the structural support; and
a power source coupled to the press.

57-61. (canceled)

62. The device of claim 55, wherein the driver includes a thrower configured to move the material particle into the nanotube blade.

63. The device of claim 55, wherein the driver is a natural magnet that magnetically interacts with the material particle and causes cutting engagement between the material particle and the nanotube blade.

64. The device of claim 55, wherein the driver is an electromagnet that magnetically interacts with the material particle and causes cutting engagement between the material particle and the nanotube blade.

65-68. (canceled)

69. The device of claim 55, further comprising a heating unit configured to heat the nanotube blade and facilitate slicing the material particle.

70-71. (canceled)

72. The device of claim 69, wherein the heating unit is an electrical resistance heater.

73. The device of claim 72, wherein the microstructure of the nanotube filament is specified to facilitate conductance.

74-75. (canceled)

76. A device for reducing the size of a material particle, comprising:
a channel configured to receive a fluid flow; and
a slicer, the slicer comprising:
a structural support; and
a nanotube blade comprising a nanotube filament having atoms arranged in a lattice structure and having a first end and a second end, wherein both the first end and the second end are coupled to the structural support and separated by a length of the nanotube blade.

77-87. (canceled)

88. The device of claim 76, wherein the slicer further comprises a plurality of overlapping nanotube blades arranged in a rectangular array with a specified array spacing, the rectangular array forming a node.

89-95. (canceled)

96. The device of claim 76, wherein the slicer further comprises a plurality of overlapping nanotube blades arranged in a triangular array with a specified array spacing, the triangular array forming a node.

97-122. (canceled)

123. The device of claim 76, further comprising an adjuster configured to vary the tension on the nanotube blade.

124. The device of claim 123, wherein the nanotube filament is under a preload tension.

125-126. (canceled)

127. The device of claim 76, further comprising a pump configured to flow a fluid through the channel.

128. The device of claim 76, further comprising a driver, wherein the driver is configured to move at least a portion of the slicer in a direction transverse to a longitudinal axis of the channel.

129. The device of claim 76, further comprising a second slicer, the second slicer comprising:
a second structural support; and
a second nanotube blade comprising a second nanotube filament having atoms arranged in a lattice structure and having a first end and a second end, wherein both the first end and the second end are coupled to the second structural support and separated by a length of the second nanotube blade.

130. The device of claim 129, further comprising a driver configured to move at least one of the first slicer and the second slicer.

131-213. (canceled)
